(19) United States
(12) Patent Application Publication
(10) Pub. No.: US 2025/0244221 A1
(43) Pub. Date: Jul. 31, 2025

(54) Rheometer and method for determining rheological properties of a viscoelastic material

(71) Applicant: Göttfert Werkstoff-Prüfmaschinen GmbH, Buchen (DE)

(72) Inventors: Joachim SUNDER, Buchen (DE); Masood KHABAZIAN ESFAHANI, Karlsruhe (DE)

(21) Appl. No.: 19/042,607

(22) Filed: Jan. 31, 2025

(30) Foreign Application Priority Data
Jan. 31, 2024 (DE) 10 2024 200 905.9

(51) Int. Cl. G01N 11/14

(52) U.S. Cl. CPC G01N 11/14

(57) ABSTRACT

A rheometer includes a test chamber for receiving a viscoelastic material for testing, wherein the test chamber is formed by an upper chamber half and a lower chamber half. The upper chamber half can be rotated relative to the lower chamber half by a rotation angle of more than 360° about an axis which extends through the chamber halves. The upper chamber half or the lower chamber half is connected to an inductive coupler to allow the transmission of electrical energy and/or electrical signals from and/or to the upper chamber half or lower chamber half which is connected to the inductive coupler to and/or from a component which is arranged at a side, which faces away from the connected upper chamber half or lower chamber half, of the inductive coupler. Furthermore, a corresponding method for determining rheological properties of a viscoelastic material having such a rheometer is set out.

The invention relates to a rheometer having a test chamber for receiving a viscoelastic material which is intended to be tested, wherein the test chamber is formed by an upper chamber half and a lower chamber half and the upper chamber half can be rotated relative to the lower chamber half by a rotation angle of more than 360° about an axis which extends through the upper and lower chamber halves.

The present invention further relates to a method for determining rheological properties of a viscoelastic material having such a rheometer.

In the context of the present invention, the viscoelastic material may be any suitable material which is accessible to a rheological measurement, for example, a viscous material, such as, for example, a polymer material.

In this case, high polymers are by far the most widespread materials which are used in countless applications, inter alia in packaging technology, the construction industry, the automotive industry, electrical industry and domestic goods industry, up to sectors of the furniture industry and agriculture.

Rheometers and methods for establishing rheological properties of a viscoelastic material with such a rheometer are known from the prior art and exist in different embodiments. For example, DE 10 2021 118 415 A1 discloses a rheometer having a test chamber for receiving a viscoelastic material which is intended to be tested, wherein the test chamber has a sample compartment 30. The test chamber is formed by an upper chamber half 4 and a lower chamber half 14, wherein the upper chamber half can be rotated relative to the lower chamber half by a rotation angle of more than 360° about an axis which extends through the upper and lower chamber halves.

Furthermore, in the known rheometer the lower chamber half 14 is connected to a slip ring 26 which—despite a rotatability through a rotation angle of more than 360°—allows an electrical path for controlling a temperature regulator inside the sample compartment 30. Such an electrical connection which is brought about via a slip ring 26 is susceptible with respect to undesirable contamination and wear during operation of the rheometer, particularly during long operating times, which may lead to electrical connection disruptions along the electrical path and therefore to unsafe and unreliable operation of the rheometer.

An object of the present invention is therefore to provide a rheometer and a corresponding method, according to which a particularly safe measurement of rheological properties of a viscoelastic material is enabled with constructively simple means.

The above object is achieved according to the invention by a rheometer having the features of claim 1 and by a method having the features of claim 11.

Accordingly, the rheometer according to the invention is configured and further developed according to claim 1 so that the upper chamber half or the lower chamber half is connected to an inductive coupler in order to allow the transmission of electrical energy and/or electrical signals from and/or to the upper or lower chamber half which is connected to the inductive coupler to and/or from a component which is arranged at a side, which faces away from the connected upper or lower chamber half, of the inductive coupler.

According to claim 11, the method according to the invention having such a rheometer has the following steps:
providing the material in the test chamber,
where applicable, driving the lower or upper chamber half in order to generate a relative movement between the lower and upper chamber halves; and
carrying out a measurement on the basis of electrical signals which are transmitted via the inductive coupler to the component by at least one sensor which is associated with the lower chamber half and/or at least one sensor which is associated with the upper chamber half.

Initially, it has been recognized according to the invention that, as a result of skillful electrical connection of the test chamber, the above object is achieved in a surprisingly simple manner. In a further simple manner according to the invention, an inductive coupler which is arranged between the test chamber and a component and which allows the transmission of electrical energy and/or electrical signals between the test chamber and the component is specifically selected for transmitting electrical energy and/or electrical signals. In this case, a transmission of electrical energy and/or electrical signals from and/or to the upper or lower chamber half which is connected to the coupler to and/or from the component is specifically allowed. Consequently, the component is arranged at a side, which faces away from the connected upper or lower chamber half, of the inductive coupler. By means of the inductive coupler, the production of a relative rotation between the lower chamber half and the upper chamber half by more than 360° about the axis which extends through the upper and lower chamber halves is solved with a simultaneous possible way of transmitting electrical energy and/or electrical signals in a manner which is free from wear and less sensitive with respect to contamination than the solution known from the prior art. Electrical connection disruptions are substantially excluded in this case.

Consequently, a rheometer and a method are provided with the rheometer according to the invention and the method according to the invention, according to which a particularly reliable measurement of rheological properties of a viscoelastic material is enabled with constructively simple means.

With regard to safe and simple temperature control of the test chamber and therefore of the material to be tested, the test chamber may be associated with a heating device or the test chamber may have such a heating device. A definable temperature can thereby be achieved during measurement. The heating device can in this instance advantageously comprise a temperature regulator or a temperature controller so that, for example, an adjustable temperature can be maintained by means of regulation during measurement. In this case, the heating device can be associated with the lower chamber half and/or the upper chamber half or be formed on or in the lower chamber half and/or the upper chamber half. Energy which is required for operating the heating device can be introduced via the inductive coupler from outside the rheometer for the heating device.

Depending on requirements and the measurement structure, the rheometer may be able to be driven in different manners, wherein the rheometer may be able to be driven, for example, in terms of oscillation or with a stationary rotation or at a constant speed. The term “at a constant speed” is intended to be understood to mean that a measurement is carried out at a constant angular speed, that is to say, not oscillating, that is, stationary.

With regard to particularly safe operation of the rheometer, the lower chamber half or the upper chamber half may be or may be able to be driven by a motor in order to rotate about the axis. In this case, specifically a hollow shaft motor or another electric motor can be used.

With regard to a constructively particularly effective configuration, the inductive coupler can be connected via the motor to the driven or drivable lower chamber half or upper chamber half. In this case, the motor is arranged between the driven or drivable, lower chamber half or upper chamber half and the inductive coupler.

In order to safely carry out different measurements which are suitable for determining rheological properties of the material, the lower chamber half and/or the upper chamber half may optionally have at least one sensor for measuring a temperature and/or a pressure, wherein the at least one sensor can record measurement data and can transmit the data as electrical signals via the inductive coupler to the component. The arrangement, type and number of sensors used can be made dependent on the necessary measurement. For example, only the lower chamber half or only the upper chamber half may have one or more sensors. Alternatively, both chamber halves may each optionally have at least one sensor. Measurement data or measurement values which are recorded with the sensor(s) can easily be transmitted as electrical signals via the inductive coupler to the component.

In a specific exemplary embodiment, the at least one sensor may be a temperature gradient sensor or may have a temperature gradient sensor. The temperature increase of the material to be tested can thereby be determined following a high shearing within a sample compartment which is formed by the two chamber halves via a detected heat flow.

In a suitable manner and in order to ensure a particularly safe measurement, the temperature gradient sensor may have at least two thermal elements or temperature sensors which are arranged at a defined spacing from each other.

Furthermore, with regard to a particularly safe measurement, respective measurement locations of the thermal elements or temperature sensors can be arranged in a material having known thermal conductivity, wherein, for example, the material may be a metal or a steel. An energy flow along the relevant sensor can thereby be determined. From this energy flow, the temperature of the material in the chamber can be calculated exactly so that rheological variables to be determined with regard to the temperature can be corrected.

In a specific exemplary embodiment, the component may be or have a measurement and/or evaluation device for rheological properties. Such a measurement and/or evaluation device may be formed by a suitable data-processing device. Furthermore, the measurement and/or evaluation device may have an integrated energy supply for a heating device of the test chamber or at least one of the two chamber halves.

Now there are different possible ways of configuring and further developing the teaching of the present invention in an advantageous manner. To this end, on the one hand, reference may be made to the dependent claims and, on the other hand, to the following explanation of a preferred exemplary embodiment of the rheometer according to the invention and the method according to the invention with reference to the drawings. In connection with the explanation of the preferred exemplary embodiment with reference to the drawings, generally preferred configurations and further developments of the teaching are also explained. In the drawings:

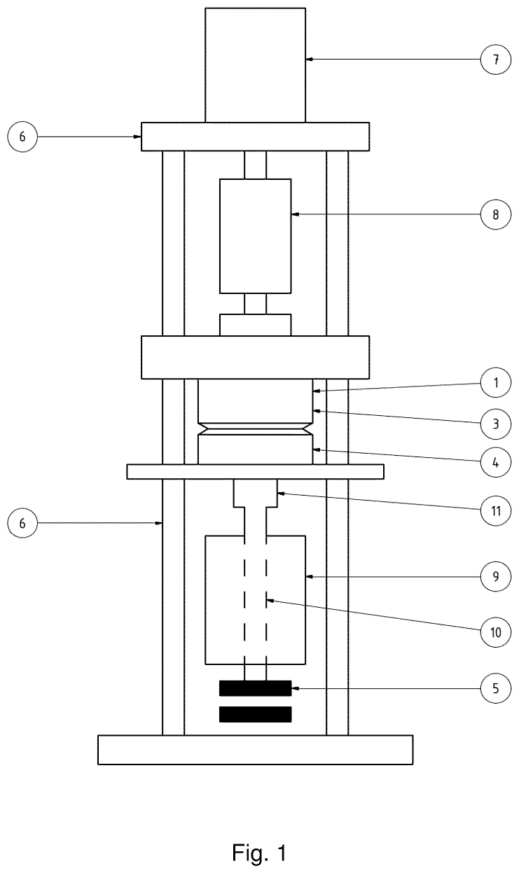

FIG. 1 shows a side view of an exemplary embodiment of the rheometer according to the invention and

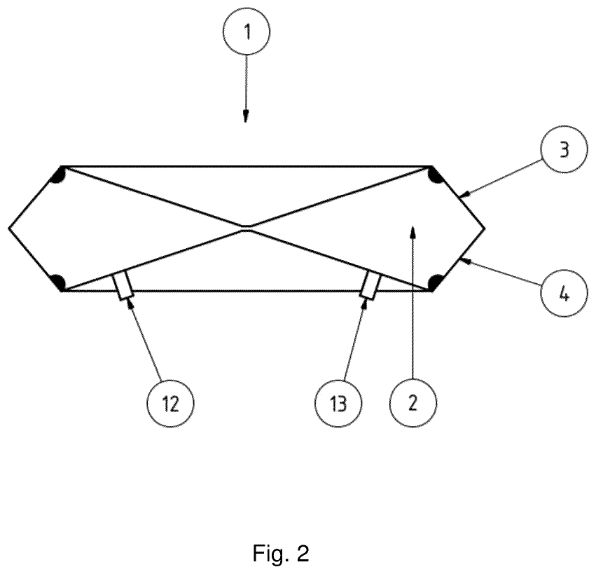

FIG. 2 shows an enlarged illustration of the test chamber of the exemplary embodiment of the rheometer according to the invention from FIG. 1.

FIG. 1 shows a side view of an exemplary embodiment of the rheometer according to the invention and FIG. 2 shows an enlarged illustration of a test chamber 1 of this exemplary embodiment. The test chamber 1 is heated and serves to receive a viscoelastic material 2 to be tested. The test chamber 1 is formed by an upper chamber half 3 and a lower chamber half 4, wherein the upper chamber half 3 can be rotated relative to the lower chamber half 4 about a rotation angle of more than 360° about an axis which extends through the upper chamber half 3 and lower chamber half 4. In the exemplary embodiment shown here, the axis extends in a vertical direction in a downward direction through the entire rheometer.

With regard to a particularly safe measurement with constructively simple means, the lower chamber half 4 is connected to an inductive coupler 5 in order to allow the transmission of electrical energy and/or electrical signals from and/or to the lower chamber half 4, which is connected to the inductive coupler 5, to and/or from a component which is not shown here and which is arranged at a side, which faces away from the connected lower chamber half 4, of the inductive coupler 5.

In the exemplary embodiment shown here, this component is formed by a measurement and/or evaluation device for rheological properties of the material. This measurement and/or evaluation device has an integrated energy supply for a heating device (not shown here) of the test chamber 1 or at least one of the two chamber halves 3, 4.

The rheometer has a frame 6, on which the components of the rheometer are arranged. A closing cylinder 7 is arranged in the upper region of the rheometer. A device 8 for measuring the torque force is produced between the closing cylinder 7 and the test chamber 1. The lower chamber half 4 can be driven by means of a hollow shaft motor 9 which has a hollow shaft 10. The hollow shaft motor 9 is actively connected to the lower chamber half 4 via a coupling device 11.

At the side, which faces away from the test chamber 1, of the hollow shaft motor 9, the inductive coupler 5 is actively connected to the hollow shaft motor 9.

In summary, the rheometer shown here is a measuring device for determining rheological properties of a viscoelastic material 2 which is or can be introduced in a temperature-controlled sample compartment between an upper chamber half 3, which is provided with two sensors, and a lower chamber half 4 which can be rotated relative to the upper chamber half, wherein the lower chamber half 4 is or can be driven by a motor. The lower chamber half 4 is connected to an inductive coupler 5 which allows the transmission of electrical energy and data, such as temperature measurement data and/or pressure measurement data, so that the lower chamber half 4 can be rotated relative to the upper chamber half 3 by more than 360°. The rheometer can function both in terms of oscillation and in the state of stationary rotation.

The inductive coupler 5 is connected to the test chamber 1 via a hollow shaft motor 9 which drives the lower chamber half 4. In this instance, the inductive coupler is located under the hollow shaft motor 9 which is connected to the test chamber 1 at the other side and which drives it. Via the inductive coupler 5, a heating device of the lower chamber half 4 can be supplied with electrical energy so that the lower chamber half 4 can be heated electrically while it rotates.

The lower chamber half 4 and optionally also the upper chamber half 5 optionally has/have at least one temperature gradient sensor 12 so that the temperature increase of the viscoelastic material 2 can be determined as a result of the high shearing within the sample compartment via the detected heat flow. The temperature gradient sensor 12 has at least two thermal elements or temperature sensors with a defined spacing. The temperature measurement locations are arranged in a steel with known thermal conductivity so that the energy flow can be determined along the sensor 12. From this energy flow, the sample temperature in the test chamber 1 can be calculated exactly so that rheological variables which are intended to be determined can be corrected with regard to the temperature.

The lower chamber half 3 and optionally also the upper chamber half has at least one pressure sensor 13 so that the pressure or the normal force can be measured directly. In the static case with a lower chamber half 4 which is not moving, the static pressure can thus be determined. During rotation or oscillation of the sample or the material 2, a normal force is produced perpendicularly to the rotation direction as a result of the viscoelastic behavior and can also be measured via the pressure sensor 13.

Generally, the rheometer can operate during rotation, that is to say, at a constant speed, or during oscillation, that is to say, with a frequency sweep with, for example, a frequency which changes abruptly or with an amplitude sweep with, for example, an amplitude which changes abruptly.

With regard to additional advantageous embodiments of the rheometer according to the invention and the method according to the invention, reference may be made to the general part of the description and the appended claims in order to avoid repetition.

Finally, it should expressly be noted that the above-described exemplary embodiment serves merely to explain the claimed teaching but does not limit it to the exemplary embodiment.

### List of Reference Numerals

1 Test chamber
2 Material
3 Upper chamber half
4 Lower chamber half
5 Inductive coupler
6 Frame
7 Closing cylinder
8 Device
9 Hollow shaft motor
10 Hollow shaft
11 Coupling device
12 Temperature gradient sensor
13 Pressure sensor

1. A rheometer having a test chamber for receiving a viscoelastic material which is intended to be tested, wherein the test chamber is formed by an upper chamber half and a lower chamber half and the upper chamber half can be rotated relative to the lower chamber half by a rotation angle of more than 360° about an axis which extends through the upper chamber half and lower chamber half,
characterized in, that the upper chamber half or the lower chamber half is connected to an inductive coupler in order to allow the transmission of electrical energy and/or electrical signals from and/or to the upper chamber half or lower chamber half which is connected to the inductive coupler to and/or from a component which is arranged at a side of the inductive coupler, wherein the side faces away from the connected upper chamber half or lower chamber half.

2. The rheometer as claimed in claim 1, wherein the test chamber is associated with a heating device preferably having a temperature regulator or temperature controller, or wherein the test chamber has such a heating device.

3. The rheometer as claimed in claim 1, wherein the lower chamber half or the upper chamber half is or can be driven by a motor in order to rotate about the axis, for example, by a hollow shaft motor.

4. The rheometer as claimed in claim 3, wherein the inductive coupler is connected via the motor to the driven or drivable lower chamber half or upper chamber half.

5. The rheometer as claimed in claim 1, wherein the rheometer can be driven in terms of oscillation or with a stationary rotation.

6. The rheometer as claimed in claim 1, wherein the lower chamber half and/or the upper chamber half has/have at least one sensor for measuring a temperature and/or a pressure, wherein the at least one sensor can record measurement data and can transmit the data as electrical signals via the inductive coupler to the component.

7. The rheometer as claimed in claim 6, wherein the at least one sensor is a temperature gradient sensor or has a temperature gradient sensor.

8. The rheometer as claimed in claim 7, wherein the temperature gradient sensor has at least two thermal elements or temperature sensors which are arranged at a defined spacing from each other.

9. The rheometer as claimed in claim 8, wherein respective measurement locations of the thermal elements or temperature sensors are arranged in a material having known thermal conductivity, wherein, for example, the material is a metal or a steel.

10. The rheometer as claimed in claim 1, wherein the component is or has a measurement and/or evaluation device for rheological properties of the material.

11. A method for determining rheological properties of a viscoelastic material having a rheometer according to claim 1, having the following steps:
providing the material in the test chamber,
where applicable, driving the lower or upper chamber half in order to generate a relative movement between the lower chamber half and the upper chamber half; and
carrying out a measurement on the basis of electrical signals which are transmitted via the inductive coupler to the component by at least one sensor which is associated with the lower chamber half and/or at least one sensor which is associated with the upper chamber half.
